(19) United States
(12) Patent Application Publication
(10) Pub. No.: US 2006/0230322 A1
(43) Pub. Date: Oct. 12, 2006

(54) Content processing device

(76) Inventor: Jun Okazaki, Kanagawa (JP)

Correspondence Address: DLA PIPER RUDNICK GRAY CARY US, LLP, 2000 UNIVERSITY AVENUE, E. PALO ALTO, CA, 94303-2248, US

(21) Appl. No.: 11/398,303

(22) Filed: Apr. 4, 2006

(30) Foreign Application Priority Data
Apr. 6, 2005 (JP) 2005-110279

(51) Int. Cl. G06F 11/00

(52) U.S. Cl. 714/49

(57) ABSTRACT

An HDD recording unit records a received content in an HDD unit based on copyright protection information. If restriction information permits compression, the content recorded in the HDD unit can be read and compressed. In this case, the original content recorded in the HDD unit is not deleted even if it is a copy-once content. Outputting the compressed content in accordance with a format for a portable terminal or the like allows watching the content on the portable terminal or the like and facilitates utilization of the content.

### CROSS-REFERENCE TO RELATED APPLICATIONS

This application is based upon and claims the benefit of priority from the prior Japanese Patent Application No. 2005-110279, filed on Apr. 6, 2005; the entire contents of which are incorporated herein by reference.

### BACKGROUND OF THE INVENTION

1. Field of the Invention

The present invention relates to a content processing device for facilitating utilization of contents by using extended copyright protection information including restriction information about compression.

2. Description of Related Art

In recent years, video and audio information and the like (hereinafter AV information) are in the course of digitization. Currently, digital broadcasting such as BS and terrestrial digital broadcasting has been started and digitized AV information (AV data) is being broadcasted as digital contents. As devices for recording such digital AV data, DVD recorders, hard disk recorders and semiconductor memory recorders, and the like, have been commercialized.

In digital recording, replication can be made without degrading original AV data. Therefore, in view of copyright protection, there is an increasing need for being able to limit copying such digital contents.

For this reason, at a side of providing contents, an arrangement is defined in which copyright protection information such as information about limiting replication of a content can be added to the content. Using the copyright protection information, a device for recording and playing the content is configured such that replication or the like violating the copyright protection information can not be made illegally.

For example, in digital broadcasting such as BS and terrestrial digital broadcasting, copyright protection information defined by DTCP (Digital Transmission Content Protocol) scheme is added to broadcasted digital contents. For analog content output from analog terminals of digital broadcast receivers, copyright protection information defined by CGMS (Copy Generation Management System) scheme is added.

Japanese Patent Laid-Open No. 2003-235001 suggests a technology regarding a device and a method for creating replication without degrading quality using copyright protection information.

The copyright protection information includes, for example, information specifying “copy-never” for never permitting replication, “copy-one-generation” for permitting replication in one generation but not permitting replication of replication (second generation), “copy-free” for permitting replication in multiple generations and the like.

Further, DTCP scheme also defines rules for content encryption and copyright information propagation if a content accompanying copyright information other than “copy-free” is accumulated in a storage medium such as a DVD or an SD memory or if transmission is made using a digital interface such as a IEEE 1394 interface.

For a content which is limited to “copy-one-generation”, DTCP scheme permits to record the content in a recording medium such as a hard disk driver for time shift watching or the like. Further, DTCP scheme also permits so-called moving operation for moving a content once recorded in a recording medium to other recording medium. In a moving operation which moves a “copy-one-generation” original content to other recording medium, while the content is recorded in other recording medium, the original content is removed from the original recording medium.

By the way, in recent years, it has also been possible for AV data to be watched on cellular phones, PDAs and the like. These portable terminals have small display size and small storage capacity. Therefore, generally, AV data played on the portable terminals is compressed with high compression rate using irreversible compression scheme such as MPEG4 or MP3 and has low video and audio accuracy.

Users can also create AV data used at such portable terminals by recompressing a digital content of digital broadcast and converting format. That is, received AV data is once recorded in a recording medium such as a hard disk, then read out and recompressed with high compression rate. Further, the AV data is converted to a format conforming to a standard for SD memories or the like available at cellular phones. This allows users to watch currently broadcasted contents at Portable terminals.

However, also in such a format conversion, a moving operation between recording media would be performed for the content. For this reason, in the current digital broadcasting adopting DTCP scheme, if such a compression operation is performed for a “copy-one-generation” content, an original content recorded in a recording medium such as a hard disk is deleted. That is, the high image quality original content is deleted in order to obtain the low image quality content for portable terminals.

Not limited to utilizing at portable terminals, if a user recompresses a content once recorded in a recording medium and records it in the recording medium, the original content is deleted. A user can not copy a content while remaining the original content even if they obtain a low image quality content which relatively require low copyright protection. Particularly, in current BS digital broadcasting and increasingly available terrestrial digital broadcasting, most contents is limited to “copy-one-generation”, thus the contents is difficult to use.

Therefore, there is a problem that when a user tries to compress an original content using the same or a different compress scheme, the original content is deleted even if image or audio quality is degraded.

### BRIEF SUMMARY OF THE INVENTION

The contents processing device according to one embodiment of the present invention comprises a copyright information addition unit configured to add copyright protection information including restriction information about compression to a content, and a sending unit configured to send the content from the copyright information addition unit to a predetermined transmission line.

The content processing device according to another embodiment of the present invention comprises a restriction information extraction unit configured to extract the restriction information from the content to which the copyright protection information including the restriction information about compression is added, and a compression unit configured to compress the content based on the restriction information extracted by the restriction information extraction unit.

The content processing device according to another embodiment of the present invention comprises a recording unit configured to receive the content to which the copyright protection information including the restriction information about compression is added and for recording it in a first recording medium based on the copyright protection information, a playback unit configured to play back the content recorded in the first recording medium, a restriction information extraction unit configured to extract the restriction information from the played-back content, a compression unit configured to compress the played-back content based on the extracted restriction information, and an output unit configured to convert and output the content compressed by the compression unit to a format which can be recorded in a second recording medium.

### BRIEF DESCRIPTION OF THE DRAWINGS

FIG. 1 is a block diagram showing a content processing device according to a first embodiment of the present invention;

FIG. 2 is an explanatory diagram showing a packet configuration in a broadcast signal output from a digital broadcast device 1;

FIG. 3A is an explanatory diagram showing an example of descriptors of restriction information about video;

FIG. 3B is an explanatory diagram showing an example of descriptors of restriction information about audio; and

FIG. 4 is a block diagram showing a content processing device according to a second embodiment of the present invention.

### DETAILED DESCRIPTION OF EMBODIMENTS OF THE INVENTION

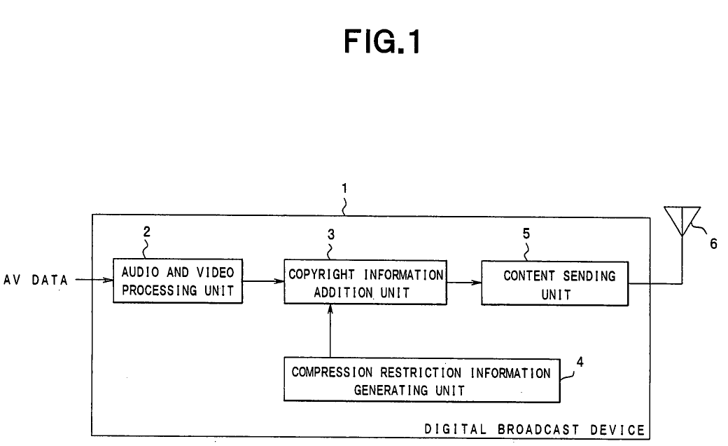

Hereunder, embodiments of the present invention are described in detail referring to the attached drawings. FIG. 1 is a block diagram that illustrates a content processing device according to the first embodiment of this invention. The device shown in FIG. 1 illustrates an example that applies the present embodiment to a content producing device for producing content at a broadcasting station. The present embodiment can also be similarly applied to producing content at a supplier that provides content over the Internet or at a content media vendor.

In FIG. 1, the content producing device has a digital broadcasting device 1. The digital broadcasting device 1 is normally composed by a plurality of devices, and not just a single device.

A video/audio processing unit 2 is provided with AV data such as video, audio or musical composition data to be broadcast as content, from a storage or video shooting device or the like (not shown), and it performs a predetermined signal processing with respect to that data. The video/audio processing unit 2 may also be equipped with a storage unit that stores AV data. For example, the video/audio processing unit 2 performs compression/expansion processing and recording/playback processing for AV data. For the compression/expansion processing, for example, the MPEG (Moving Pictures Experts Group) 2 system that is employed for current digital broadcasting can be used. The video/audio processing unit 2 is configured to output AV data that was packetized in MPEG2-TS (transport stream) format. In this connection, a compression system or data transfer format and the like, in the video/audio processing unit 2 is not particularly limited.

The AV data from the video/audio processing unit 2 is supplied to a copyright information addition unit 3. The copyright information addition unit 3 adds copyright protection information to the AV data. As the copyright protection information, for example, information that complies with the DTCP system can be employed. Copyright protection information that complies with the DTCP system includes information specifying “copy-never”, “copy-one-generation”, “copy-free” or the like as described above.

A compression restriction information generating unit 4 generates restriction information about compression (recompression) for content that was broadcast. More specifically, the compression restriction information generating unit 4 stipulates restrictions for a case in which a user that receives and utilizes the content recompresses and records the content.

For example, restriction information generated by the compression restriction information generating unit 4 includes information indicating whether duplication of recompressed AV data is permitted or not permitted, as well as limitations for image quality and sound quality when recompressing and the like.

The compression restriction information generating unit 4 generates restriction information based on information about recompression that conforms to copyright protection rules established by the content provider or broadcasting station. The following kinds of information can be considered as restriction information.

a. Restrictions Relating to Compression Systems

Video and audio are normally compressed using separate systems, and restrictions are thus placed on the compression systems for video and audio, respectively. In the next-generation DVD standards, the H.264 system and compression/expansion systems for video are adopted in addition to the current MPEG-2 system. For example, the compression restriction information generating unit 4 can set individual restrictions that correspond to these compression systems, such as permitting duplication using the H.264 system for video and permitting duplication using the AC3 (Audio Codec number 3) system for audio.

b. Restrictions for Image Quality or Sound Quality of Content by Recompression

For example, with respect to video data, restrictions for settings such as the maximum bit rate, number of pixels, frame rate, and interlacing or noninterlacing of the content after recompression can be considered. For audio, restrictions can be considered for settings such as the bit rate, sampling frequency, quantifying bit number and number of audio channels of the content after recompression.

c. Restrictions Regarding Whether or not to Permit Further Duplication with Respect to Duplication of Content that was Produced by Recompression at the User Side

For example, for content that was recompressed and duplicated, the setting of restrictions regarding whether or not to permit further duplication or restrictions relating to the compression system, image quality and sound quality and the like when further duplication is permitted can also be considered.

Various methods can be considered as ways for setting these restrictions. For example, use of a plurality of compression systems, and not just a single compression system, can also be permitted by the restriction information. Further, with respect to image quality and sound quality, a setting method can also be considered whereby restrictions are set that permit duplication or the like under the condition that the quality is below a predetermined upper limit.

The compression restriction information generating unit 4 outputs the set restriction information in a predetermined format. For example, as the restriction information, the value of each bit in a bit string of a predetermined format may be set to either “1” or “0” in accordance with the restriction conditions. Further, each restriction condition may be set according to a predetermined value, or the restriction conditions may be specified by text data.

The restriction information from the compression restriction information generating unit 4 is supplied to the copyright information addition unit 3. The copyright information addition unit 3 is configured to add and output the copyright protection information (restriction information) that was produced by the compression restriction information generating unit 4 to the content along with other copyright protection information.

In this connection, although the foregoing described a case in which the compression restriction information generating unit 4 generates restriction information about compression and the copyright information addition unit 3 adds copyright protection information and the restriction information, respectively, to the content, a configuration may also be adopted whereby copyright protection information that is expanded in relation to recompression of copyright protection information to include restriction information is generated by the compression restriction information generating unit 4 or the copyright information addition unit 3.

A content sending unit 5 as a sending unit performs sending processing for content to which restriction information about compression and copyright protection information (hereunder, these are referred to in combination as “copyright protection information including restriction information”) were added. Examples of the sending processing performed by the content sending unit 5 include scrambling processing for conditional access to the content, multiplex processing that multiplexes the contents of a plurality of programs onto a single radio wave, processing to add an error-correcting code, scrambling processing to prevent eavesdropping of the broadcasting airwaves, and modulation processing that performs modulation that is compatible with the broadcast.

A broadcast signal from the content sending unit 5 is supplied to an antenna 6, and the antenna 6 sends the broadcast signal.

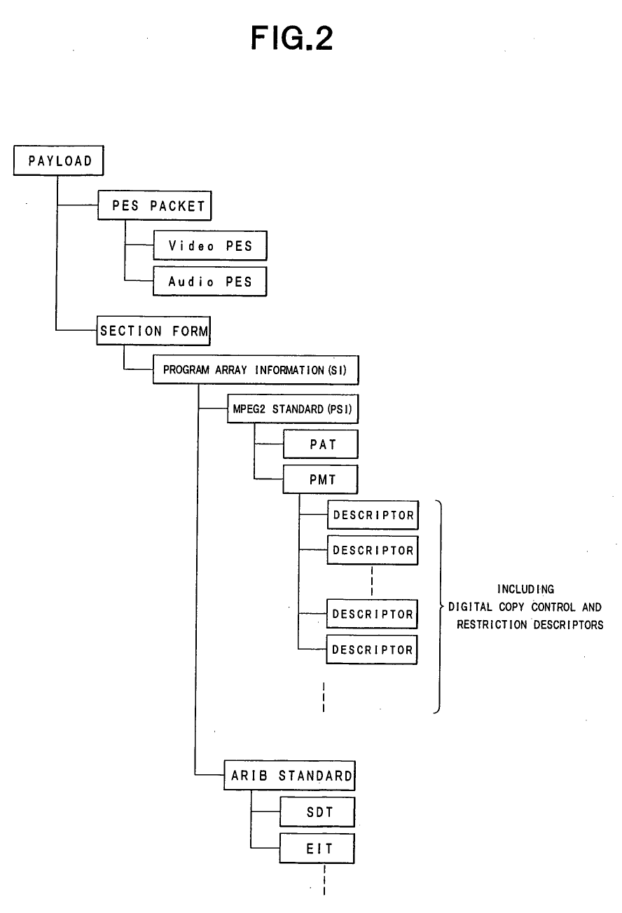

FIG. 2 is an explanatory diagram showing the packet configuration of a broadcast signal that is output from the digital broadcasting device 1.

The copyright information addition unit 3 adds restriction information and copyright protection information to the content in accordance with the format of the data to be sent (transmitted). For example, the copyright information addition unit 3 adds copyright protection information and restriction information to the content in accordance with the data sequence of MPEG-TS packets that is employed for current broadcasting. FIG. 2 illustrates an example that adopts the current digital broadcasting. In this case, the copyright information addition unit 3 defines the copyright protection information including restriction information by means of a descriptor in the broadcast signal.

MPEG standards are employed for digital broadcasting. With MPEG, data can be transmitted in a transport stream that takes into account the transmission of a plurality of programs in a single stream. A transport stream is composed by fixed-length packets (transport packets) of 188 bytes that include a one-byte synchronization signal, and includes video data, audio data, and other data. A transport stream adds a link level header before a payload that transmits information, and is then transmitted. Four bytes of the 188 bytes of the transport packet constitute the link level header.

The link level header includes a PID (packet identification) as the identification information of the packet, a transport scrambling control that indicates the existence or nonexistence of scrambling, and the like.

A stream of video data and audio data and the like is transmitted by an elementary stream (ES). A packetized elementary stream (PES) packet is configured by adding a header to an ES. Since a PES packet is relatively large, it is transmitted by payloads of several transport packets.

In contrast, for other types of data, in most cases the data is transmitted by a data structure referred to as a section. That is, a PES and a section are transmitted on a transport stream by time sharing. A plurality of types of PES and a plurality of types of sections can be transmitted by a transport stream, and these data can be separated and extracted on the receiving side by an MPEG decoder that refers to the PID.

As shown in FIG. 2, service information (SI) is included in a section. The service information (SI) includes program specific information (PSI) that is defined by MPEG-2. The PSI is demultiplexing information that describes the structure and the like of a plurality of programs that were multiplexed. The PSI includes a program association table (PAT) that describes a transmission identifier for the detailed information of each program and a program map table (PMT) that describes detailed information such as the structure of each program and a transmission identifier thereof for all the multiplexed programs. The PSI is sent by multiplex transmission in a fixed-length packet together with video and audio signals and the like.

The service information (SI) also includes, for example, a service definition table (SDT) that describes detailed information of the service (the constitutive channels) or an event information table (EIT) that describes detailed information of programs in the service. The service information (SI) is also sent by multiplex transmission together with the video and audio signals.

Various kinds of descriptors can be allocated in the service information (SI). In current digital broadcasting, a digital copy control descriptor in accordance with the DTCP protocol is defined as one of the PMT descriptors allocated for each program. This digital copy control descriptor makes it possible to specify “copy-never”, “copy-one-generation” or “copy-free” as described above.

In the present embodiment, for example, restriction information is described as one descriptor in the PMT. In this case, as described above, in addition to a digital copy control descriptor in accordance with the DTCP protocol, a descriptor (restrictions descriptor) for restriction information about compression may be provided, or the digital copy control descriptor may be extended to provide a digital copy control descriptor that includes restriction information.

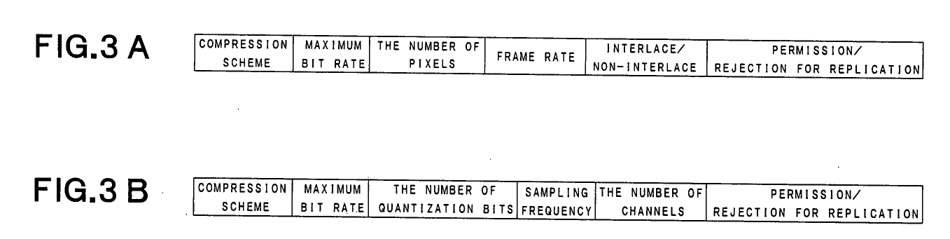

FIG. 3A and FIG. 3B are explanatory diagrams that illustrate examples of a descriptor for restriction information.

FIG. 3A illustrates a descriptor for restriction information about video, and FIG. 3B illustrates a descriptor for restriction information about audio. The descriptor relating to video includes information indicating the compression system, the maximum bit rate, the number of pixels, the frame rate, whether interlacing or noninterlacing is employed, and whether or not further duplication of content that was recompressed and duplicated is permitted. The descriptor relating to audio includes information indicating the compression system, the maximum bit rate, the quantifying bit number, the sampling frequency, the number of channels, and whether or not further duplication of content that was recompressed and duplicated is permitted.

According to the embodiment configured in this manner, copyright protection information including restriction information is added to the content for transmission.

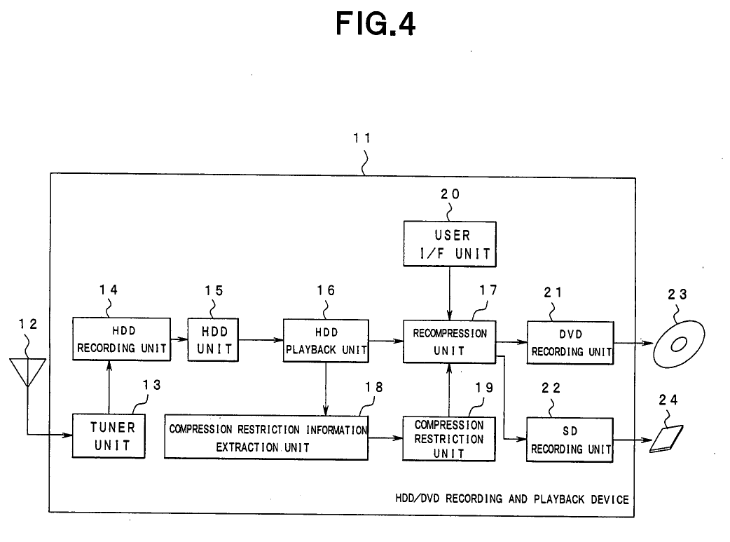

FIG. 4 is a block diagram showing a content processing device according to the second embodiment of this invention. The device shown in FIG. 4 is an example of a receiving device that receives the content to which copyright protection information including restriction information was added as described above. The present embodiment is applied to a DVD recorder and playback device with a built-in hard disk.

A broadcast signal that was received by an antenna 12 is input to an HDD/DVD recorder and playback device 11. The antenna 12, for example, supports UHF and can receive digital terrestrial broadcasting waves. The HDD/DVD recorder and playback device 11 receives, for example, digital terrestrial broadcast signals from the antenna 12 and can record the signals on the hard disk or a DVD and also record them on a memory card such as an SD card. The HDD/DVD recorder and playback device 11 may also comprise a next-generation DVD such as an HDDVD or a Blue-ray DVD, or a hologram memory or the like.

A broadcast signal from the antenna 12 is supplied to a tuner unit 13. The tuner unit 13 has an unshown circuit unit relating to reception demodulation. For example, the tuner unit 13 is composed by a tuning unit that tunes into an airwave, a demodulating unit that demodulates modulated data, a descrambling unit that descrambles a scrambled signal, an error correcting unit that performs error correction, a CAS descrambling unit that descrambles scrambling that was carried out for the purpose of conditional access (CAS (conditional access system)), and an MPEG2-TS processor that performs processing for MPEG2-TS and the like.

The tuner unit 13 receives a broadcast signal from the antenna 12, demodulates the signal, and outputs it to an HDD recording unit 14. For example, the tuner unit 13 can output an MPEG2-TS. The tuner unit 13 also extracts copyright protection information that is included in the broadcast signal. For example, the MPEG2-TS processor inside the tuner unit 13 extracts copyright protection information inside the MPEG2-TS and carries out processing to manage the propriety of duplication or the duplication generations. More specifically, the tuner unit 13 controls recording of the MPEG2-TS in the HDD recording unit 14 based on copyright protection information that is extracted from each of the contents.

The MPEG2-TS processor of the tuner unit 13, for example, extracts a digital copy control descriptor that was described as a PMT descriptor shown in FIG. 2, to thereby control the recording. When the copyright protection information is information indicating “copy-one-generation”, the MPEG2-TS processor performs control to change the digital copy control descriptor to a descriptor indicating “no more copies” and cause the content in question to be recorded.

The HDD recording unit 14 has unshown circuit units for performing recording of content at an HDD unit 15 as a hard disk. For example, the HDD recording unit 14 includes a determining unit that determines the propriety of recording based on copyright protection information, a converting unit that converts the format of content from MPEG2-TS into MPEG2-PS (program stream), an encrypting unit that performs encryption as necessary when recording content, and a recording control unit that controls recording to the hard disk.

The determining unit within the HDD recording unit 14 determines the propriety of recording to the HDD unit 15 based on the copyright protection information, and prohibits recording to the HDD unit 15 for content with a “copy-never” restriction. When the copyright protection information specifies “copy-one-generation” or “copy-free”, the determining unit permits recording to the HDD unit 15. When the copyright protection information that was extracted by the tuner unit 13 indicates “copy-one-generation”, the HDD recording unit 14 performs recording to the HDD unit 15 after converting the copyright protection information to indicate “no more copies”.

As the HDD unit 15, for example, a commercially available standard hard disk device for a personal computer can be employed.

Further, the HDD recording unit 14 may not only convert the format of content to MPEG2-PS for recording, but may also record the content as it is in MPEG-TS format, or may record the content after converting it to another format. The HDD recording unit 14 makes the copyright protection information and restriction information compatible to the respective recording format and records them on the HDD unit 15 in a state in which they are added to the content.

An HDD playback unit 16 has unshown circuit units that perform playback processing of content recorded on the HDD unit 15. For example, the HDD playback unit 16 includes a playback control unit that plays back data from the HDD unit 15, and an encryption/decryption unit that returns read data to plaintext when the data was encrypted and the like. Time-shift playback of content can be performed by supplying content that was played back by the HDD playback unit 16 to an unshown display system. An illustration of a playback system has been omitted in FIG. 4.

In this embodiment, a recompression unit 17 that compresses playback content from the HDD unit 15 is provided. The manner of recompression in the recompression unit 17 as a compression unit is prescribed by the restriction information. A compression restriction information extraction unit 18 extracts restriction information that is included in a playback signal from the HDD playback unit 16, and outputs the restriction information to a compression restricting unit 19. The compression restricting unit 19 performs processing to restrict the operations of the recompression unit 17 based on the compression restriction information that was extracted by the compression restriction information extraction unit 18.

The recompression unit 17 compresses playback content from the HDD playback unit 16 under the control of the compression restricting unit 19. For example, the recompression unit 17 has one or a plurality of video and audio compression processing units, and can compress playback content according to one or a plurality of compression systems. For example, the recompression unit 17 can compress video and audio data using the MPEG-2 system, the H.264 system, the WMV system, and the MPEG 4 format and the like. In this case, the compression restricting unit 19 restricts not just the method of compression but also the data compression ratio and the like for the compression processing performed by the recompression unit 17.

The recompression unit 17 may also be equipped with a copyright information processing unit that refers to copyright protection information in the original content and writes the generation of the recompressed duplicate.

A user interface 20 performs processing to present the state and conditions of recompression in the recompression unit 17 and the like to a user. The user interface 20 also provides recompression processing instructions to the recompression unit 17 based on a user operation relating to recompression processing. The recompression unit 17 is configured to perform compression processing in accordance with instructions from the user interface 20. The functions of the user interface 20 are realized, for example, by a remote control device for the apparatus or an on-screen display of a television screen.

In the example illustrated in FIG. 4, the recompression unit 17 can perform compression according to at least the MPEG-2 system and the MPEG-4 system. Content that was compressed by the recompression unit 17 is supplied to a recording unit that corresponds with the respective compression system. In the example shown in FIG. 4, content that was compressed using the MPEG-2 system is supplied to a DVD recording unit 21 and content that was compressed using the MPEG-4 system is supplied to an SD recording unit 22. The DVD recording unit 21 and the SD recording unit 22 constitute output units respectively.

The DVD recording unit 21 has unshown circuit units that perform processing for recording recompressed content on a DVD media 23. For example, the DVD recording unit 21 is composed by an authoring unit that authors the content in a DVD format, an encrypting unit that performs encryption as necessary when recording the content, and a recording control unit that controls the recording onto the DVD.

The SD recording unit 22 has unshown circuit units that perform processing for recording recompressed content on an SD card 24. For example, the SD recording unit 22 is composed by an encrypting unit that performs encryption as necessary when recording the content, and a recording control unit that controls the recording onto the SD card.

In the embodiment configured in this manner, restriction information is extracted from the content, and compression (recompression) of the content is carried out based on the extracted restriction information.

Next, a specific example of content production processing and recompression processing of received content will be described.

In FIG. 1, the content to be broadcasted is supplied to the video/audio processing unit 2. The video/audio processing unit 2 performs predetermined signal processing on the content and outputs it in a predetermined format to the copyright information addition unit 3. For example, the video/audio processing unit 2 outputs content A with the conditions shown hereunder.

<Content A>

Video . . . high-definition television video data compressed using the MPEG-2 system (1920×1080i)

Audio . . . data with 48 kHz sampling frequency, 384 kbps bit rate, and 5.1 channels compressed using MPEG-2 AAC (Advanced Audio Coding)

Meanwhile, the compression restriction information generating unit 4 is supplied with recompression-related information that conforms to copyright protection rules established by the content provider or broadcasting station. Based on this information, the compression restriction information generating unit 4 generates restriction information about recompression of the content and outputs this restriction information to the copyright information addition unit 3.

For example, the compression restriction information generating unit 4 generates the restriction information shown hereunder.

<Restrictions Information>

Video restrictions

Compression system: H.264 system and MPEG-4 system

Maximum bit rate: 768 kbps

Pixels: 352×480

Frame rate: 30 frames/second

Interlace

Audio restrictions

Compression system: MP3 (MPEG-1 Audio Layer 3)

Maximum bit rate: 128 kbps

Quantifying bit number: 16 bit

Sampling frequency: 48 kHz

Number of channels: 2 channels

Duplication of second generation and later after recompression

Further duplication of recompressed and duplicated content is not permitted.

The copyright information addition unit 3 adds copyright protection information that is prescribed by, for example, the DTCP protocol to content A together with the restriction information about recompression that was generated by the compression restriction information generating unit 4. For example, the compression restriction information generating unit 4 describes copyright protection information including restriction information by means of a descriptor within the PMT of the MPEG2-TS.

For example, the compression restriction information generating unit 4 sets “copy-one-generation” as the copyright protection information of the DTCP protocol.

The content A to which the copyright protection information including restriction information was added is supplied to the content sending unit 5. The content sending unit 5 further attaches, for example, data for data broadcasting or an electronic program list or the like to content A, and multiplexes this with the content of other programs. The content sending unit 5 also performs processing to add error-correcting codes, scrambling processing, modulation processing and the like, and then outputs a broadcast signal to the antenna 6. A broadcast signal including content A is thus transmitted by airwaves.

This broadcast signal is received by the HDD/DVD recorder and playback device 11 shown in FIG. 4 to perform recording of content A. The broadcast signal received by the antenna 12 is supplied to the tuner unit 13. The tuner unit 13 carries out tuning processing, demodulation processing, descrambling processing, error correction processing and CAS descrambling processing and the like. The tuner unit 13 also retrieves the MPEG2-TS using the MPEG2-TS processor and extracts the copyright protection information inside the MPEG2-TS.

The tuner unit 13 outputs the MPEG2-TS and the copyright protection information to the HDD recording unit 14. The HDD recording unit 14 records the content onto the HDD unit 15 under the control of the tuner unit 13.

At this time, it is assumed that a user made an instruction to record content A of the received broadcast signal on the HDD unit 15. The HDD recording unit 14 determines the propriety of recording content A based on the copyright protection information. Since “copy-one-generation” has been set for content A, the HDD recording unit 14 determines that recording of content A onto the HDD unit 15 is permitted. The HDD recording unit 14 records the MPEG2-TS containing content A on the HDD unit 15. In this case, the HDD recording unit 14 changes the copyright protection information that is described in the descriptor inside the PMT of the MPEG2-TS from “copy-one-generation” to “no-more-copy” before performing the recording. Further, since confidentiality of the content to be recorded on the HDD unit 15 is required by the DTCP protocol, the HDD recording unit 14 performs encryption processing as necessary.

In this connection, instead of changing the copyright protection information when recording to the HDD unit 15, a configuration may be adopted in which the copyright protection information is changed at the time of playback in the HDD playback unit 16.

Further, the HDD recording unit 14 may extract the data of content A from the MPEG2-TS and, for example, record the data on the HDD unit 15 after converting it to MPEG2-PS.

The content A that was recorded on the HDD unit 15 can be played back by the HDD playback unit 16. For example, when the user designates time-shift playback for content A, the HDD playback unit 16 reads out content A that is recorded on the HDD unit 15, decrypts the encryption or decodes the MPEG2-TS or the like, and after obtaining the AV data for content A, outputs the AV data to a circuit of an unshown display system. In this connection, if decoding processing for the MPEG2-TS or MPEG2-PS can be performed in a circuit of the display system, the HDD playback unit 16 may output the read compressed data to the circuit of the display system as it is.

At this time, it is assumed that the user makes an instruction to compress content A to record content A on an SD card in order to, for example, listen to content A on a trial basis using a cellular phone. In this case, the HDD playback unit 16 outputs the played back data to the recompression unit 17. Meanwhile, the compression restriction information extraction unit 18 extracts restriction information about recompression relating to content A that is recorded on the HDD unit 15, and outputs the restriction information to the compression restricting unit 19.

More specifically, the compression restriction information extraction unit 18 extracts restriction information that was assigned as a PMT descriptor of the MPEG2-TS. The compression restricting unit 19 controls recompression processing of the recompression unit 17 based on the input restriction information.

The recompression unit 17 presents the compression-related restriction conditions that are supplied from the compression restricting unit 19 to the user through the user interface 20. By referring to this presentation the user can specify a compression system, image quality, sound quality and the like that conform the restriction conditions. The specification is supplied to the recompression unit 17 through the user interface 20. When only one compression system is permitted and the restrictions relating to image quality, sound quality and the like are fixed values, the recompression unit 17 may automatically perform recompression without prompting the user for instructions relating to compression.

In the restriction information that was set for content A, the H.264 system and the MPEG-4 system are prescribed as the compression systems. The user can designate the compression system through the user interface 20. For example, it is assumed here that the user selects the MPEG-4 system. In that case, the recompression unit 17 carries out compression processing using the MPEG-4 system on a playback signal from the HDD playback unit 16. The recompression unit 17 converts the input MPEG-TS directly into MPEG-4 system data.

In this connection, the recompression unit 17 may decode the MPEG-TS system playback signal to restore the original AV data and perform compression processing using the MPEG-4 system for the restored AV data of content A. Further, when a playback signal from the HDD playback unit 16 is AV data, the recompression unit 17 may perform compression processing using the MPEG-4 system for the input AV data of content A.

When performing this compression processing, the compression processing of the recompression unit 17 is controlled by the compression restricting unit 19, and the recompression unit 17 carries out the compression processing in accordance with the aforementioned restriction information about compression. More specifically, in this case, the compressed data of content A that is generated by recompression is restricted to interlaced video data for which the maximum bit rate is 768 kbps, the pixel number is 352×480 and the frame rate is 30 frames/second. Further, the audio data of content A is restricted to data for which the maximum bit rate is 128 kbps, the quantifying bit number is 16 bit, the sampling frequency is 48 kHz and the number of channels is two channels.

The recompression unit 17 also attaches restriction information indicating that further duplication of the content that was recompressed and duplicated is not permitted, to the data compressed using the MPEG-4 system. The recompression unit 17 similarly reflects required information contained in the copyright protection information of the original content prior to recompression, in the compressed data after recompression.

Although the foregoing described a case of using the MPEG-4 system, this embodiment is not limited to the MPEG-4 system, and the recompression unit 17 may insert the restriction information in a format that is in accordance with the compression system. When there is no format for reflecting the copyright protection information in compressed data that was recompressed, the copyright protection information including restriction information may be output to the DVD recording unit 21 or the SD recording unit 22 of the subsequent stage to reflect the copyright protection information including restriction information in the recording format.

Furthermore, when the recompression unit 17 is unable to perform processing according to the compression system, image quality, sound quality and the like that is specified by the restriction information about compression, it presents a message to the user to the effect that recompression is not possible through the user interface 20, and may also enable discontinuation of duplication processing for the recompression data.

Compression data that was compressed using the MPEG-4 system is supplied from the recompression unit 17 to the SD recording unit 22. The SD recording unit 22 subjects the recompressed content A to format conversion for recording on an SD card, and then records the recompressed content A on the SD card 24. More specifically, the SD recording unit 22 multiplexes the video data and audio data that were recompressed by separate systems in a format that can be recorded on the SD card 24 and, where necessary, attaches other information and authors the content. When further duplication is prohibited, the SD recording unit 22 also performs processing to encrypt and record the content.

The content A that was recorded on the SD card 24 was compressed using the MPEG-4 system and can be played back by a cellular phone or the like. For example, the SD card 24 can be installed in an unshown cellular phone, whereby the recorded content A can be read out and played back to make it possible to watch to content A utilizing a display screen of the cellular phone.

In this connection, for example, when recording content A on the DVD 23, the recompression unit 17 compresses content A according to, for example, the MPEG-2 system and outputs the compressed content A to the DVD recording unit 21. In this case, the DVD recording unit 21 performs format conversion for content A and then records content A on the DVD 23.

In this way, in the above embodiment, restriction information about compression is added to a content when the content is produced. On the other hand, when using the content, the recorded content may be read and recompressed and a replication may be made. The recorded original content is still not deleted as a result of recompressing the “copy-one-generation” content and making a replication, as long as complying with a rule in the restriction information. This allows making a replication of the recompressed AV data while remaining the original content. For example, if a compressed data with low image or audio quality is made in order to use the original content on a portable terminal or the like, the original content with high image quality is not deleted, thus use of the content can be significantly facilitated and it is very convenient for users.

For example, it is also effective for use of contents such as recompressing a plurality of original contents and recording them into one DVD, or recording a compressed data as a backup data.

In the first embodiment, although the content production device has been described with respect to the digital broadcast device, the first embodiment may similarly apply to content delivery via Internet with a different AV data format.

Further, the first embodiment may similarly apply to a device for producing package media such as current DVDs. In an example of current DVDs, an authoring device is used instead of the digital broadcast device in FIG. 1. AV data format output from the audio and video processing unit 2 is MPEG2-PS. In this case, the copyright information addition unit 3 can store the copyright protection information with header portion in DVD format including the restriction information. Also, the content sending unit 5 is configured to add information except for copyright information as a DVD recording portion, perform authoring in DVD format and record it in a DVD. In this way, the data from the content sending unit 5 is recorded in the DVD medium.

In the second embodiment, although exemplary configuration comprising both an HDD and a DVD has been illustrated, a device may comprise a plurality of HDDs or a plurality of DVDs.

Although the example of receiving a content of digital broadcasting and once recording it in the HDD unit as the original content has been described, it is also conceivable to recompress the received content and record it directly into the HDD unit, a DVD or the like without recording the received content. In this case, it is possible to make a replication of the recompressed content within the range of a restriction conditions if the restriction information permits recompression, even though the content is “copy-never”.

In this case, the output from the tuner unit 13 is provided to the recompression unit 17 while the compression restriction information extraction unit 18 extracts the compression restriction information from the output of the tuner unit 13. Other operations are similar.

In the second embodiment, although the configuration has been described in which the recompressed content is recorded in a DVD or an SD card, a configuration is also conceivable in which the recompressed content is output to a digital interface conforming to, for example, IEEE1394 standard. In this case, a content recompressed in a corresponding device connected via the interface is recorded, and an output from the recompression unit 17 is output via the digital interface unit, not shown.

Similarly, a configuration is also conceivable in which a content input from an external device via a digital interface conforming to IEEE1394 standard is recompressed, instead of recompressing a broadcast content. In this case, instead of the tuner unit 13, an output from the digital interface unit, not shown, is provided to the HDD recording unit 14 or the like.

In the embodiment in FIG. 4, although playback systems for DVD and SD card are not shown, these systems can be included.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A content processing device comprising:
a copyright information addition unit configured to add copyright protection information including restriction information about compression to a content, and
a sending unit configured to send the content from the copyright information addition unit to a predetermined transmission line.

2. The content processing device according to claim 1, wherein:
the sending unit sends the content from the copyright information addition unit by broadcasting the content as a broadcast signal or via Internet.

3. The content processing device according to claim 1, wherein:
the copyright protection information including the restriction information about compression includes information about restriction of recording the content and information about restriction of compression in the case of compressing the content with a predetermined compression scheme, and
the restriction of compression defined by the restriction information about compression is independent of restriction based on the information about restriction of recording the content.

4. The content processing device according to claim 1, wherein:
restriction of compression defined by the restriction information about compression permits to make a replication without deleting the recorded content when the recorded content is played and compressed, even if copy-once is set to the content.

5. The content processing device according to claim 1, wherein:
the copyright information addition unit describes the copyright protection information including the restriction information about compression within a descriptor in service information according to MPEG standard.

6. The content processing device according to claim 1, wherein:
the restriction information about compression includes information about a compression scheme of the content and quality of the compressed content at playback.

7. A content processing device comprising:
a restriction information extraction unit configured to extract restriction information about compression from a content to which copyright protection information including the restriction information is added, and
a compression unit configured to compress the content based on the restriction information extracted by the restriction information extraction unit.

8. The content processing device according to claim 7, wherein:
the copyright protection information including the restriction information about compression includes information about restriction of recording the content and information about restriction of compression in the case of compressing the content with a predetermined compression scheme, and
the restriction of compression defined by the restriction information about compression is independent of restriction based on the information about restriction of recording the content.

9. The content processing device according to claim 8, wherein:
the compression unit compresses the content based on the restriction information about compression even if prohibit-copy is set to the content.

10. The content processing device according to claim 8, comprising:
a recording unit to which the content is provided and configured to record the content based on the information about restriction of the recording,
wherein the restriction information about compression permits to compress the content and make a replication without deleting the recorded content when the content recorded by the recording unit is played and compressed, even if copy-once is set to the content.

11. The content processing device according to claim 8, wherein:
the restriction information about compression includes information about a compression scheme of the content and quality of the compressed content at playback.

12. A content processing device comprising:
a recording unit configured to receive a content to which copyright protection information including restriction information about compression is added and for recording the content in a first recording medium based on the copyright protection information,
a playback unit configured to play back the content recorded in the first recording medium,
a restriction information extraction unit configured to extract the restriction information from the played-back content,
a compression unit configured to compress the played-back content based on the extracted restriction information, and
an output unit configured to convert and output the content compressed by the compression unit to a format which can be recorded in a second recording medium.

13. The content processing device according to claim 12, wherein:
the copyright protection information including the restriction information about compression includes information about restriction of recording the content and information about restriction of compression in the case of compressing the content with a predetermined compression scheme, and
the restriction of compression defined by the restriction information about compression is independent of restriction based on the information about restriction of recording the content.

14. The content processing device according to claim 12, wherein:
the compression unit performs compression processing based on an instruction for compression from external when compressing the content, within the range defined by the restriction information about compression.

15. The content processing device according to claim 12, wherein:
the content output from the output unit includes a reduced version of an image included in the content recorded by the recording unit.

16. The content processing device according to claim 12, wherein:
the second recording medium is readable by a portable terminal.

17. The content processing device according to claim 12, wherein:
the second recording medium is a portable medium.

18. The content processing device according to claim 12, wherein:
the restriction information about compression permits to compress the content and make a replication without deleting the content recorded in the first recording medium if copy-once is specified by the copyright protection information.

19. The content processing device according to claim 12, wherein:
the restriction information about compression includes information about a compression scheme of the content and quality of the compressed content at playback.
